(19) United States
(12) Patent Application Publication
(10) Pub. No.: US 2008/0297689 A1
(43) Pub. Date: Dec. 4, 2008

(54) LIQUID CRYSTAL DISPLAY DEVICE

(75) Inventor: Kazunari NISHITA, Nomi-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 12/185,666

(22) Filed: Aug. 4, 2008

Related U.S. Application Data
(62) Division of application No. 11/398,591, filed on Apr. 6, 2006.

(30) Foreign Application Priority Data
Apr. 7, 2005 (JP) 2005-111238

(51) Int. Cl. G02F 1/1333

(52) U.S. Cl. 349/58

(57) ABSTRACT

A liquid crystal display device which prevents a reflecting sheet from contacting the electrically continuing part of a flexible print wiring board (FPC) is disclosed. In the liquid crystal display device furnished with a light guiding plate 1 serving to emit the light of a light source in a prescribed direction, a reflecting sheet 2 so disposed as to lie parallel to the back of the light guiding plate 1, a second frame part 4 so disposed as to fix the light guiding plate 1, and a flexible print wiring board (FPC) 5 intended to effect electric connection, a leading terminal 2a of the reflecting sheet 2 is so disposed as to be positioned on the inner side of the second frame part 4a.

### BACKGROUND OF THE INVENTION

This application is a divisional of and claims the benefit of priority under 35 USC § 120 from U.S. Ser. No. 11/398,591, filed Apr. 6, 2006, the entire contents of which are incorporated herein by reference. This application is also is based upon and claims the benefit of priority under 35 USC § 119 from the Japanese Patent Application No. JP 2005-111238, filed Apr. 7, 2005.

1. Field of the Invention

This invention relates to a liquid crystal display device and particularly to the type of device which prevents the occurrence of contact between a reflecting sheet and a flexible print wiring board in a lighting unit thereof.

2. State of the Prior Art

In recent years, as the display devices of such information machines as notebook type personal computers and word processors and the display devices of such image machines as portable television sets, video movies, and car navigation systems, the liquid crystal display devices have come to be used in more cases than not with a view to utilizing such features as lightness, thinness, and low power consumption. For the most part, these liquid crystal display devices, with the object of realizing a bright display screen, are so configured as to make a lighting unit throw a light on a display element from behind.

For this lighting unit, the edge light method which comprises placing a light guiding plate behind the display element and disposing a linear light source using a fluorescent discharge tube, for example, along the end face of the light guiding plate enjoys a special feature of excelling in the ability to allow decrease of thickness and ensure uniformity of luminance of a light emitting plane. As the method of back light for the liquid crystal display device which is used as in a notebook type personal computer, this edge light method is adopted more often than not by giving priority to the thinness. For the liquid crystal display devices which are used as in portable telephones and personal digital assistance (PDA) tools, the edge light method which has light sources such as fluorescent discharge tubes disposed one each along the opposite lateral sides of the light guiding plate and the edge light method which has such a light source disposed along only one side are adopted in most cases.

FIG. 4 depicts one example of the liquid crystal display device LCD 6 used in the conventional portable telephone, which device is furnished with a liquid crystal display panel P, a lighting unit UT of the edge light method, a flexible print wiring board (FPC) 5 intended to effect electric connection, etc. The lighting unit UT is provided with a flat transparent light guiding plate 1 serving to transmit the light of a light source h to the whole of an irradiating surface, a reflecting sheet 2 serving to reflect the light of the light guiding plate 1, and a frame part 4 serving to fix the light guiding plate 1 and the liquid crystal display panel P mentioned above. Here, one side terminal of the reflecting sheet 2 is fixed, though not invariably, in conjunction with the light guiding plate 1 from above by dint of a second frame 4a of the frame part 4. The liquid crystal display panel P is formed by having a liquid crystal layer nipped between a pair of base plates on the irradiating surface side (the upper part in the bearings of FIG. 4) of the lighting unit UT. An external control circuit serving to control the liquid crystal display device LCD is disposed on a circuit board independent of the liquid crystal display panel P and is connected to an internal circuit of the liquid crystal display panel P through the medium of the flexible print wiring board (FPC) 5. On the flexible print wiring board (FPC) 5, a pattern wiring, a land, and an electronic part 5b intended to effect electric connection are mounted. Incidentally, Patent Document 2 discloses the concept of causing a sheet material such as a reflecting sheet incorporated in a back light for a liquid crystal display element to be fixed in a storing concave of a frame instead of resorting to an adhesive means such as, for example, a double coated adhesive agent.

[Patent Document] Official gazette of JP-A 2001-350004

[Patent Document] Official gazette of JP-A 2004-264400

Incidentally, as the reflecting sheet, the kind of reflection sheet which possesses a metal layer evaporated from a metal such as silver, for example, excels in corrosion resistance and light fastness and tends to find use as a high-reflection film. When the reflecting sheet possessing a metal layer and allowing continuity through a leading terminal (end face) is put to use, therefore, it possibly entails the situation of suffering the land and the wiring pattern of the flexible print wiring board (FPC) for driving the light source and the electrically continuing parts such as electronic parts mounted on the flexible print wiring board, owing to the positional relation between the flexible print wiring board (FPC) and the reflecting sheet, to contact the leading terminal (end face) of the reflecting sheet and give rise to a short circuit. Specifically, in the example of FIG. 4, since a leading terminal (end face) 2z of the reflecting sheet 2 is exposed from an outer side wall 4z of a second frame part 4a of the frame 4, the incorporation of this liquid crystal display device LCD in an electronic unit (such as, for example, a portable telephone, a PDA, or a miniature terminal) possibly entails accidental contact of the leading terminal (end face) 2z with the electrically continuing part of the flexible print wiring board (FPC) and consequently causes the relevant product to form a short circuit.

### SUMMARY OF THE INVENTION

It is, therefore, an object of this invention to provide a liquid crystal display device which is directed toward the prevention of contact between a reflecting sheet and a flexible print wiring board (FPC).

The liquid crystal display device of this invention is furnished with a liquid crystal display panel incorporating a liquid crystal layer therein between two base plates, a back light unit, and a flexible wiring board having an electronic part mounted thereon and adapted to effect electric connection with the liquid crystal display panel and is characterized by the fact that the aforementioned back light unit is furnished with a light guiding plate for emitting the light of a light source in a prescribed direction, a reflecting sheet disposed along the back of the light guiding plate, and a frame intended to fix the light guiding plate and the liquid crystal display panel, the aforementioned frame is furnished with a first frame part extended in a direction nearly parallel to the light guiding plate and a second frame part extended in a direction from the back of the first frame part toward the reflecting sheet side and nearly perpendicular to the light guiding plate, the second frame part having the reflecting sheet disposed on the inside thereof and the flexible print wiring board disposed on the outside thereof, and the aforementioned reflecting sheet has the leading terminal thereof on the flexible print wiring board side disposed so as to be positioned more toward the light guiding plate side than toward the inner side wall of the second frame part. In accordance with this invention, since the leading terminal of the reflecting sheet on the flexible print wiring board side is so disposed as to be positioned more toward the light guiding plate side than toward the inner side wall of the second frame part, it is made incapable of contacting the flexible print wiring board (FPC) and inducing a serious situation of short circuit.

This invention optionally uses such a configuration that the leading terminal of the reflecting sheet on the flexible print wiring board side may be enabled, by bending the reflecting sheet till it lies parallel to the inner side wall of the second frame part, to be positioned more toward the light guiding plate side than toward the inner side wall of the second frame part. This configuration enables the leading terminal of the reflecting sheet to prevent not only leak of light from a light source but also invasion of dust in addition to ceasing to induce accidental contact with the flexible print wiring board (FPC).

And, the liquid crystal display device of this invention is furnished with a liquid crystal display panel incorporating a liquid crystal layer therein between two base plates, a back light unit, and a flexible wiring board having an electronic part mounted thereon and adapted to effect electric connection with the liquid crystal display panel and is characterized by the fact that the aforementioned back light unit is furnished with a light guiding plate for emitting the light of a light source in a prescribed direction, a reflecting sheet disposed along the back of the light guiding plate, and a frame intended to fix the light guiding plate and the liquid crystal display panel, the aforementioned frame is furnished with a first frame part extended in a direction nearly parallel to the light guiding plate and a second frame part extended in a direction from the back of the first frame part toward the reflecting sheet side and nearly perpendicular to the light guiding plate, the second frame part having the reflecting sheet disposed on the inside thereof and the flexible print wiring board disposed on the outside thereof, and the aforementioned reflecting sheet has the leading terminal thereof on the flexible print wiring board side inserted in a notch formed in the inner side wall of the second frame part.

In accordance with this invention, the leading terminal of the reflecting sheet on the flexible print wiring board side is made incapable of exposing itself to the exterior and contacting the flexible print wiring board (FPC) owing to the fact that it is inserted in the notch formed in the inner side wall of the second frame. Besides, the notch mentioned above can be utilized as a standard of alignment when the reflecting sheet is fixed on the frame.

In accordance with this invention, the reflecting sheet is made incapable of contacting the flexible print wiring board (FPC) and inducing a situation of short circuit owing to the fact that the leading terminal of the reflecting sheet is so disposed as to be positioned on the inside of the second frame part. Since the reflecting sheet so formed as to lie parallel to the inner side wall of the second frame part is also capable of preventing not only leak of light from a light source but also invasion of dust, the liquid crystal display device aimed at by this invention is enabled to excel in luminous intensity and insusceptibility to the influence such as of dust. Further, in accordance with this invention, by enabling the leading terminal of the reflecting sheet to be inserted in the notch formed in the second frame part thereby keeping it from contacting the flexible print wiring board (FPC) and inducing a situation of short circuit and also enabling the notch to serve as a standard of alignment during the fixation of the reflecting sheet on the frame, the operation of assembling can be facilitated and the reflecting sheet can be exactly fixed in position.

### BRIEF DESCRIPTION OF THE DRAWINGS

FIG. 1 is a cross section of a liquid crystal display device in one mode of embodiment of this invention.

FIG. 2 is a cross section of a liquid crystal display device in another mode of embodiment of this invention.

FIG. 3 is a cross section of a liquid crystal display device in still another mode of embodiment of this invention.

FIG. 4 is a cross section of a conventional liquid crystal display device.

### DESCRIPTION OF THE PREFERRED EMBODIMENTS

The present mode of embodiment, as illustrated in FIG. 1, consists in a liquid crystal display device LCD for use in a portable telephone. This device is furnished with a liquid crystal display panel P, a lighting unit UT of the edge light method, and a flexible print wiring board adapted to effect electric connection between the aforementioned liquid crystal display device LCD and an electronic unit (such as, for example, a portable telephone, a PDA, or a miniature terminal) incorporating the aforementioned liquid crystal display device LCD therein. The aforementioned flexible print wiring board 5 is fixed at a prescribed position of the aforementioned electronic unit and adapted to effect electric connection between the liquid crystal display device LCD and the aforementioned electronic unit. Incidentally, the method for fixing the flexible print wiring board 5 and the aforementioned electronic unit mutually is not depicted in the drawing because it is irrelevant to this invention.

The lighting unit (back light unit) UT is furnished with a flat transparent light guiding plate 1 serving to transmit the light of a light source (LED) h to the whole of an irradiating surface, a reflecting sheet 2 serving to reflect the light advancing behind the light guiding plate 1, and a frame 4 for fixing the light guiding plate 1 and the reflecting sheet 2 together. The light guiding plate 1 is formed of such a material as acrylic resin endowed with ideal optical properties represented by transmission factor and refractive index which are necessary for transmission of light. This light guiding plate 1 has formed on the back thereof dot patterns or groove patterns (not shown) varied in shape proportionately to the distance from the light source.

The reflecting sheet 2 possesses a role of exalting the illuminating light by sending the light tending to escape from behind the light guiding plate 1 to the ambience back into the light guiding plate 1 and is so disposed as to lie parallel to the back of the light guiding plate 1. This reflecting sheet 2 uses a white resinous film endowed with high reflectance and possesses a metal layer resulting from evaporating such a metal as silver. Possessing such a metal layer as this enables the resultant reflecting film to acquire high quality excelling also in corrosion resistance and light fastness. The reflecting sheet 2 in the present mode of embodiment utilizes this metal layer as a reflecting layer. It may lack the metal layer but incorporate such means as possesses a necessary reflecting function (such as, for example, something which has a surface coated with a reflecting [non-metallic reflection] material). Though the use of this non-metallic reflecting material brings an exceptional decrease of the probability of inducing a short circuit with an electronic part, this invention embraces the concept of using this material because the configuration of this invention is expected to produce such effects as exalting the light blocking property of the aforementioned liquid crystal display device LCD, facilitating the positioning of the reflecting sheet, and consequently improving the efficiency of a relevant operation. The possession of the metal layer nevertheless is especially significant because it has a high probability of inducing a short circuit in consequence of contacting the flexible print wiring board (FPC) 5.

The frame 4 fulfills not only the role of fixing the liquid crystal display panel P and the light guiding plate 1 mutually but also the role of fixing the reflecting sheet 2 in position and as well possesses a protruding part (hereinafter referred to as the second frame part) 4a which fixes one side terminal of the reflecting sheet 2. Though the aforementioned light guiding plate 1 does not need to be invariably fixed from above, it is fixed from above in the present mode of embodiment. The frame 4 in the present mode of embodiment is furnished with a first frame part 4b extended in a direction nearly parallel to the light guiding plate 1 and a second frame part 4a extended in a direction from the back 4x of the first frame part 4b toward the reflecting sheet 2 side and nearly perpendicular to the light guiding plate 1; on the assumption that the direction of disposition of the light guiding plate 1 as viewed from the lateral face of the aforementioned liquid crystal display device LCD constitutes the inside, the reflecting sheet 2 is disposed on the inside of the second frame part 4a and the aforementioned flexible print wiring board (FPC) 5 is disposed on the outside of the second frame part 4a.

A leading terminal 2a of the reflecting sheet 2 on the flexible print wiring board 5 side is disposed so as to be positioned more toward the light guiding plate 1 side than toward an inner side wall 4y of the second frame part 4a. As a result, the leading terminal 2a is made capable of ceasing to contact the land of the flexible print wiring board (FPC) 5, the wiring pattern, and the electronic part 5b and preventing the situation of inducing a short circuit with these electrically continuing parts (FIG. 1). Further the present mode of embodiment finds it proper to have the reflecting sheet 2 bent nearly in the shape of the letter L along the inner side wall 4y of the second frame part 4a and the leading terminal 2a thereof consequently directed toward the liquid crystal display panel P side as illustrated in FIG. 3. Even in this configuration, since the leading terminal 2a is so disposed as to be positioned more toward the light guiding plate 1 side than toward the inner side wall 4y of the second frame part 4a, it is made capable of ceasing to contact the land of the flexible print wiring board (FPC) 5, the wiring pattern, and the electronic part 5a and consequently preventing the situation of inducing a short circuit with such electrically continuing parts. Besides, this configuration is capable of preventing not only leak of light from the light source h to the outside of the second frame part 4a but also invasion of dust through a gap S intervening between the second frame part 4a of the frame 4 and the light guiding plate 1 and enabling the resultant liquid crystal display device LCD to enjoy good luminous intensity and exhibit insusceptibility of the influence such as of dust.

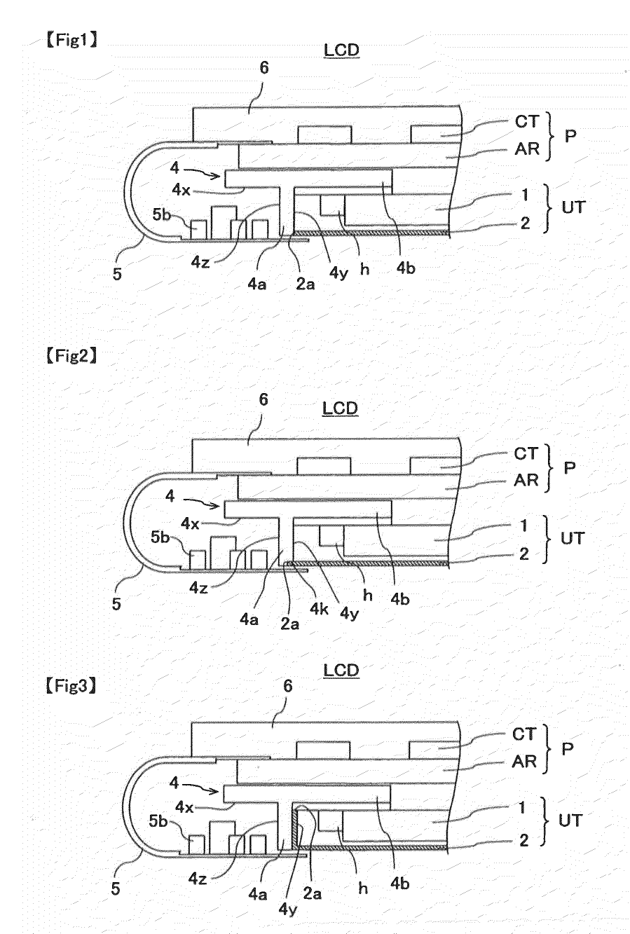

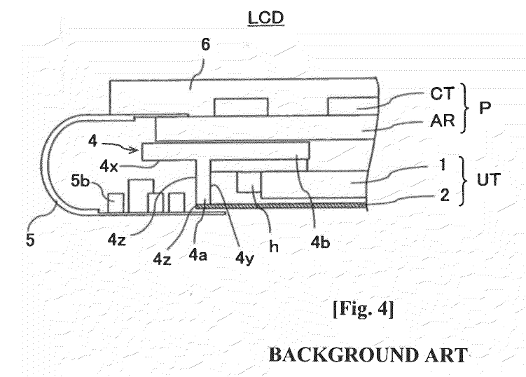

As another mode of embodiment, the liquid crystal display device LCD which, as illustrated in FIG. 2, has nearly the same configuration as the liquid crystal display device LCD (FIG. 1) described above with the exception of having a notch 4k formed in the inner side wall 4y of the second frame part 4a and having the leading terminal 2a of the reflecting sheet 2 on the flexible print wiring board 5 side inserted to the notch 4k. Making the insertion in the notch 4 as described above results in preventing the leading terminal 2a of the reflecting sheet 2 from exposing to the exterior and contacting the flexible print boarding plate (FPC) 5, particularly the electrically continuing parts. Besides, this mode of embodiment is made capable of enabling the notch 4k to serve as a standard of alignment during the work of fixing the reflecting sheet 2 on the frame 4, facilitating the operation of assemblage, and further allowing the reflecting sheet 2 to be exactly fixed in position.

The flexible print wiring board (FPC) 5 which, as illustrated as in FIG. 1, has the liquid crystal display device LCD assembled by mounting the liquid crystal display panel P on the lighting unit UT on the irradiating surface side (in the upper part in the drawing) and electrically connecting the flexible print wiring board (FPC) 5 thereto is connected exclusively to the liquid crystal display panel P at this stage. Thereafter, the aforementioned flexible print wiring board 5 is fixed at a prescribed position on the aforementioned electronic unit with the object of establishing electric connection between the liquid crystal display device LCD and the electronic unit (not shown).

In the present mode of embodiment, since the reflecting sheet 2 is so formed as to be prevented from contacting the electrically continuing parts of the flexible print wiring board (FPC) 5, the short circuit otherwise caused by the contact can be prevented.

The invention has been described in detail with particular reference to preferred embodiments thereof. It will be understood, however, that variations and modifications can be effected within the spirit and scope of the invention.

I claim:

1. A liquid crystal display device furnished with a liquid crystal display panel incorporating a liquid crystal layer therein between two base plates, a back light unit, and a flexible wiring board having an electronic part mounted thereon and adapted to effect electric connection with the liquid crystal display panel and characterized by
said back light unit being furnished with a light guiding plate for emitting the light of a light source in a prescribed direction, a reflecting sheet disposed along the back of the light guiding plate, and a frame intended to fix the light guiding plate and the liquid crystal display panel,
said frame being furnished with a first frame part extended in a direction nearly parallel to the light guiding plate and a second frame part extended in a direction from the back of the first frame part toward the reflecting sheet side and nearly perpendicular to the light guiding plate, said second frame part having the reflecting sheet disposed on the inside thereof and the flexible print wiring board disposed on the outside thereof, and said reflecting sheet having the leading terminal thereof on the flexible print wiring board side inserted in a notch formed in the inner side wall of said second frame.

2. A liquid crystal display device according to claim 1, wherein said reflecting sheet is formed by coating a resinous sheet with a metal layer.
